(19) United States
(12) Patent Application Publication
(10) Pub. No.: US 2025/0291150 A1
(43) Pub. Date: Sep. 18, 2025

(54) LENS ACTUATION DEVICE

(71) Applicant: Intelligent Mechatronics Industry Co., Ltd., Taoyuan City (TW)

(72) Inventor: Chi-Wei Chiu, Taoyuan City (TW)

(21) Appl. No.: 19/076,865

(22) Filed: Mar. 11, 2025

(30) Foreign Application Priority Data
Mar. 14, 2024 (TW) 113109391

(51) Int. Cl. G02B 7/08

(52) U.S. Cl. CPC G02B 7/08

(57) ABSTRACT

A lens actuation device includes a base, a lens holder unit, and a driving unit. The base has a first guiding pin and a second guiding pin. The lens holder unit has a first extension part and a second extension part, and a first guiding hole, a second guiding hole, a guiding tube, and a limiting element are provided on the first extension part and the second extension part respectively. The guiding tube corresponds to the first guiding hole and is disposed on one side of the first extension part, the first guiding pin penetrates into the guiding tube. The limiting element is disposed on the other side of the first extension part. The driving unit has a motor body, an output shaft, and a lifting nut. The lens holder unit can be moved smoothly through the guiding pin.

### CROSS-REFERENCE TO RELATED APPLICATION

This application claims the priority benefit of Taiwan application (No. 113109391), filed on Mar. 14, 2024. The entirety of the above-mentioned patent application is hereby incorporated by reference herein and made a part of this specification.

### FIELD OF THE INVENTION

The present invention relates to an actuation device, and more particularly to an optical lens actuation device.

### BACKGROUND OF THE INVENTION

Small or mini camera modules are one of standard configurations for a plurality of mobile devices, which are usually equipped in laptops, mobile phones, tablets, and the like. Additionally, with the growing popularity of outdoor sports in recent years, action cameras unmanned aerial vehicles, or the like are increasingly widely used. In the above applications, an auto-focus function is an indispensable requirement especially for the motion cameras and unmanned aerial vehicles.

The auto-focus requires a lens module to be moved to achieve the best focusing effect. During the movement of the lens module, a dynamic tilt of a lens is effectively controlled, which will impact the overall quality of the focusing effect. Therefore, how to provide a lens actuation device to suppress tilting during lens movement is currently one of the important issues.

### SUMMARY OF THE INVENTION

In view of this, one objective of the present invention is to provide a lens actuation device, which can effectively control an inclination angle of a lens during movement, and prevent tilting.

To achieve the above objective, the present invention provides a lens actuation device, including a base, a lens holder unit, and a driving unit. The base is provided with a base opening, a first guiding pin, and a second guiding pin, where the first guiding pin and the second guiding pin are respectively disposed on a surface on two sides of the base opening. The lens holder unit is provided with a lens holder opening, a first extension part, a second extension part, a first guiding hole, a second guiding hole, a guiding tube, and a limiting element. The lens holder opening is corresponding to the base opening, the first extension part and the second extension part extend outward from the lens holder opening, the first guiding hole is formed in the first extension part, and the second guiding hole is formed in the second extension part. The guiding tube is corresponding to the first guiding hole and disposed on one side of the first extension part, the first guiding pin penetrates into the guiding tube, and the limiting element is disposed on the other side of the first extension part. The driving unit is provided with a motor body, an output shaft, and a lifting nut, a part of the output shaft is connected to the motor body, the other part of the output shaft is screwed with the lifting nut, a part of the first extension part of the lens holder unit is located between the motor body and the lifting nut, and the lifting nut is limited by the limiting element to rotate relative to the limiting element.

In an embodiment, the lens actuation device further includes a circuit unit, provided with a circuit board, a driving control element, and a sensing element. The circuit unit is disposed on one side of the base and the lens holder unit, and a surface of the circuit board faces the base and the lens holder unit. The sensing element is disposed on the surface of the circuit board and is disposed to be opposite to a positioning element of the lens holder unit.

In an embodiment, the lens actuation device further includes a shell, the shell is provided with a shell opening corresponding to the base opening and the lens holder opening, and the shell is connected to the base to envelop the lens holder unit, the driving unit, and the circuit unit.

In an embodiment, the limiting element of the lens holder unit is further provided with a first limiting column and a second limiting column, the lifting nut is provided with a protrusion, and the protrusion is located between the first limiting column and the second limiting column for movement restriction.

In an embodiment, the driving unit is further provided with a support, and the support is provided with a first part, a second part, and a third part. The first part abuts against a side that is of the output shaft of the motor body and that extends outward. The second part is connected to the first part. The third part is connected to the second part and disposed to be opposite to the first part, one terminal end of the output shaft is connected to the third part, and the lifting nut is located between the first part and the third part.

In an embodiment, the base is further provided with a setting groove, a first support column, and a second support column. The setting groove is located on one side of the first guiding pin. The first support column is disposed on one side of the setting groove. The second support column is disposed on the other side of the setting groove. The support is disposed in the setting groove and is connected to the first support column and the second support column separately.

In an embodiment, the lens holder unit is further provided with a reset spring and a longitudinal groove. The reset spring is sleeved on an outer side of the guiding tube. The longitudinal groove is located on one side of the first extension part, and the output shaft of the driving unit penetrates into the longitudinal groove.

In an embodiment, the lens actuation device further includes an upper cover, the upper cover is superimposed on the lens holder unit and is provided with a first fastening hole and a second fastening hole, the first fastening hole is corresponding to the first guiding pin, the second fastening hole is corresponding to the second guiding pin, and the guiding tube and the reset spring are located between the upper cover and the first extension part of the lens holder unit.

To sum up, in the lens actuation device of the present invention, through mutual cooperation of the guiding pin, the guiding hole, and the guiding tube, the guiding tube and the first guiding hole that are closed can move along the first guiding pin, and the second guiding hole can move along the second guiding pin, and through cooperation of the output shaft and the lifting nut of the driving unit, tilting and rotation of the lens holder unit during movement can be prevented, and then accurate focusing position control can be further obtained.

### BRIEF DESCRIPTION OF THE DRAWINGS

FIG. 1 is a schematic exploded view of a lens actuation device according to a preferred embodiment of the present invention;

FIG. 2 is a schematic diagram of a combination of a driving unit and a lens holder unit; and

FIG. 3 is a schematic diagram of a combination of a base, the lens holder unit, the driving unit, and a circuit unit of the lens actuation device.

### DETAILED DESCRIPTION OF PREFERRED EMBODIMENTS

To enable those skilled in the art to understand the content of the present invention and to implement the content of the present invention accordingly, the present invention is described as follows in combination with preferred embodiments and accompanying drawings.

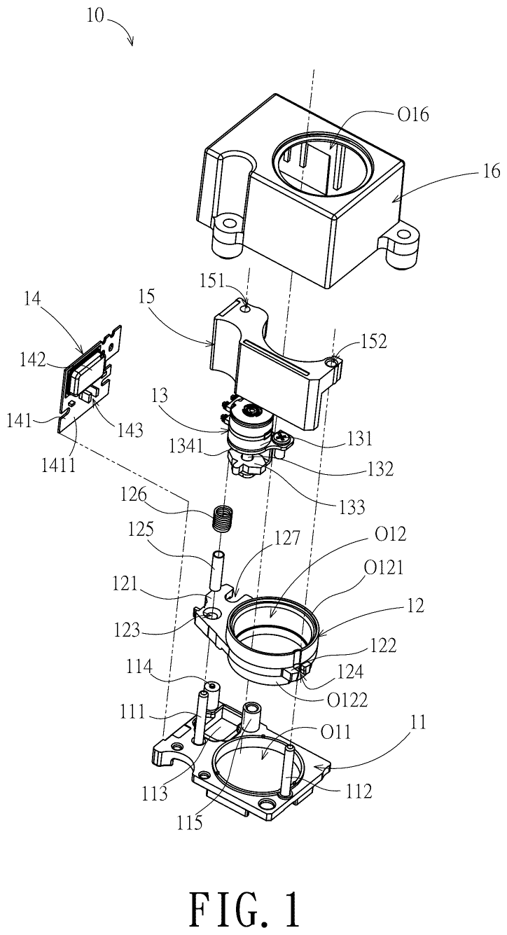

Refer to FIG. 1. A lens actuation device 10 in a preferred embodiment of the present invention includes a base 11, a lens holder unit 12, a driving unit 13, a circuit unit 14, an upper cover 15, and a shell 16.

The base 11 is provided with a base opening O11, a first guiding pin 111, a second guiding pin 112, a setting groove 113, a first support column 114, and a second support column 115. The first guiding pin 111 and the second guiding pin 112 are respectively disposed on two sides of the base opening O11. In detail, the first guiding pin 111 and the second guiding pin 112 are extended along an axial direction of the base opening O11 from a surface of the base 11 and stand on two sides of the base opening O11. The two sides are rough positions, and a connection between the two is not limited to passing through a center of a circle of the base opening O11. The setting groove 113, the first support column 114, and the second support column 115 are located on one side of the first guiding pin 111, and the first support column 114 and the second support column 115 are respectively disposed on two sides of the setting groove 113.

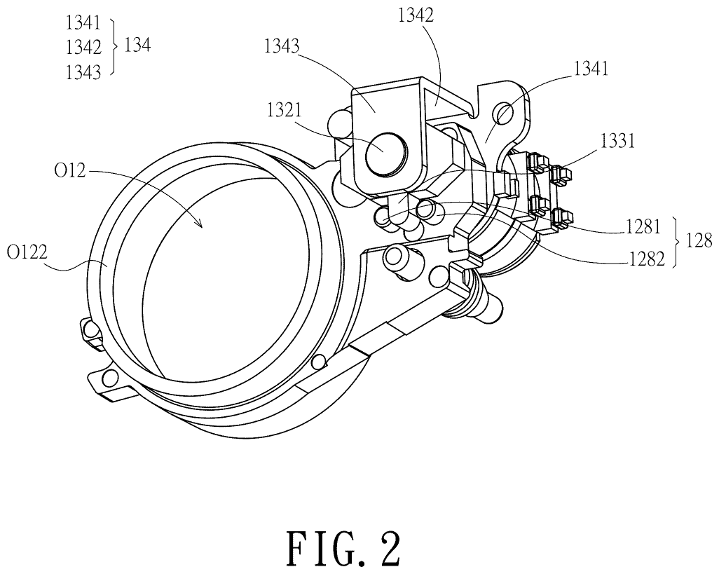

Refer to FIG. 1 and FIG. 2. The lens holder unit 12 is provided with a lens holder opening O12, a first extension part 121, a second extension part 122, a first guiding hole 123, a second guiding hole 124, a guiding tube 125, a reset spring 126, a longitudinal groove 127, and a limiting element 128.

The lens holder opening O12 is used to accommodate a lens (not shown in the figure). The first extension part 121 and the second extension part 122 are extended outward from two sides of the lens holder opening O12. The first guiding hole 123 is formed in the first extension part 121, and the second guiding hole 124 is formed in the second extension part 122. The guiding tube 125 is connected to the first guiding hole 123, extends along an axial direction of the lens holder opening O12, and stands on the first extension part 121. The reset spring 126 is sleeved on an outer side of the guiding tube 125. In a different embodiment, the first guiding hole 123 and the second guiding hole 124 may be designed to be closed or semi-closed, which is not limited herein. For example, in this embodiment, the first guiding hole 123 is closed, and the second guiding hole 124 is semi-closed. The longitudinal groove 127 is located on one side of the first extension part 121. As shown in FIG. 2, the limiting element 128 includes two limiting columns, which are respectively a first limiting column 1281 and a second limiting column 1282, and are disposed on the other surface of the first extension part 121 relative to the guiding tube 125. In addition, the lens holder opening O12 is formed by a lens holder with an upper half O121 and a lower half O122 based on the first extension part 121, and both are round.

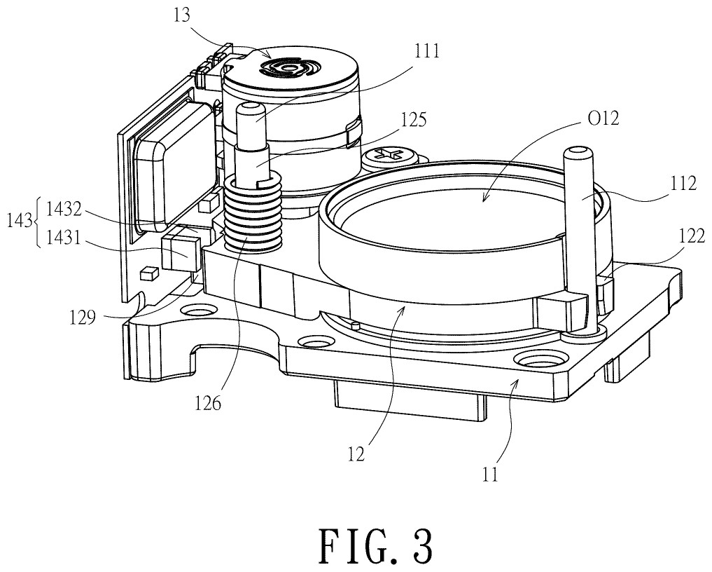

Further, still refer to FIG. 1 and FIG. 3. The lens holder unit 12 is superimposed above the base 11. The lens holder opening O12 is corresponding to a position of the base opening O11, the first guiding hole 123 is corresponding to a position of the first guiding pin 111, and the second guiding hole 124 is corresponding to a position of the second guiding pin 112. The guiding tube 125 extends in a direction away from the base 11, so that after the lens holder unit 12 is assembled with the base 11, the first guiding pin 111 penetrates into the first guiding hole 123 and the guiding tube 125, and the second guiding pin 112 penetrates into the second guiding hole 124.

Still refer to FIG. 1 and FIG. 2. The driving unit 13 may be a stepping motor, which is provided with a motor body 131, an output shaft 132, a lifting nut 133, and a support 134. The output shaft 132 is a lead screw, one part of the output shaft is connected to the motor body 131, and the other part is screwed with the lifting nut 133 through a thread. The output shaft 132 is driven by the motor body 131 to rotate. The support 134 includes a first part 1341, a second part 1342, and a third part 1343. The first part 1341 and the third part 1343 are arranged in a sheet shape and opposite to each other, and the second part 1342 is connected between the first part 1341 and the third part 1343. The first part 1341 abuts against one side of the motor body 131, namely, a side on which the output shaft 132 extends outward. In addition, one terminal end 1321 of the output shaft 132 is connected to the third part 1343, and the lifting nut 133 is located between the first part 1341 and the third part 1343. In addition, the first part 1341 of the support 134 is firmly connected to the first support column 114 and the second support column 115 to fasten the driving unit 13.

Further, the third part 1343 of the support 134 is disposed in the setting groove 113 of the base 11. The output shaft 132 located in the support 134 penetrates into the longitudinal groove 127 of the lens holder unit 12, and the limiting element 128 of the lens holder unit 12 is configured to fasten the lifting nut 133, to limit the rotation of the lifting nut 133 relative to the limiting element 128. In this embodiment, the limiting element 128 is provided with a first limiting column 1281 and a second limiting column 1282, and the lifting nut 133 is provided with a protrusion 1331 located between the first limiting column 1281 and the second limiting column 1282 for movement restriction. In this case, the fastening means that the lifting nut 133 cannot rotate with the rotation of the output shaft 132, and when the output shaft 132 rotates, the lifting nut 133 moves up and down with the forward or reverse rotation of the output shaft 132, thereby driving the lens holder unit 12 to be displaced.

It can be learned, from a connection relationship between the support 134, the first support column 114, the second support column 115, and the driving unit 13, that the first support column 114 and the second support column 115 can also be configured to support the stepping motor. In addition, it should be noted that cooperation between the limiting column and the protrusion 1331 is only an example illustration, and a different configuration may be provided based on the purpose. For example, an implementation for the protrusion 1331 is changed to being sleeved on the limiting column.

Still refer to FIG. 1 and FIG. 3. The circuit unit 14 is provided with a circuit board 141, a driving control element 142, and a sensing element 143. The circuit unit 14 is erected on one side of the base 11 and the lens holder unit 12, and one surface 1411 of the circuit board 141 faces the base 11 and the lens holder unit 12.

The circuit board 141 may be a printed circuit board or a flexible printed circuit board, which may be a single-layer circuit board, a double-sided circuit board, or a multi-layer circuit board, which is not limited herein. The sensing element 143 is disposed on a surface 1411 of the circuit board 141, and the driving control element 142 may be optionally disposed on the same surface 1411 as the sensing element or on an opposite surface.

The driving control element 142 is electrically connected to the driving unit 13, and includes but is not limited to active electronic components such as a control chip, a driving chip, and/or a processing chip, as well as other passive electronic components. The sensing element 143 is a light sensing element, which includes a light emitter 1431 and a light receiver 1432 arranged in opposite directions. It should be noted that the sensing element 143 is disposed to face the lens holder unit 12, and one side surface of the lens holder unit 12 is also provided with a positioning element 129, which may be a protrusion located between the light emitter 1431 and the light receiver 1432. During up and down movement of the lens holder unit 12, the positioning element 129 moves accordingly. Therefore, light emitted by the light emitter 1431 is shielded at different positions to varying degrees, thereby affecting the light received by the light receiver 1432 and causing a change in an output voltage. Therefore, a voltage change is analyzed, so that an amount of movement of the lens holder unit 12 can be effectively detected. Position information can be obtained, and a position of the lens holder unit 12 can also be controlled to implement automatic focusing.

The above is an embodiment in which light sensing is used for position determining. In another embodiment, the sensing element 143 may also use magnetic field sensing as position determining. For example, the sensing element 143 can be a magnetic hall sensor, and the positioning element 129 of the lens holder unit 12 can be replaced with a magnet, such as a permanent magnet, so that a position of the lens holder unit 12 can be sensed by a change in a magnetic field. It should be noted that positions at which the sensing element and the positioning element are located are interchangeable without restriction on the premise that a sensing result is not affected.

Still refer to FIG. 1. The upper cover 15 is superimposed on the lens holder unit 12. Further, the upper cover 15 is roughly corresponding to the first extension part 121 and the second extension part 122 of the lens holder unit 12. The upper cover 15 is provided with a first fastening hole 151 and a second fastening hole 152. The first fastening hole 151 is corresponding to the first guiding pin 111. To be specific, the first guiding pin 111 penetrates the first guiding hole 123 and the guiding tube 125, and is then connected to the first fastening hole 151. In addition, the guiding tube 125 and the reset spring 126 are restricted to a position between the upper cover 15 and the first extension part 121 of the lens holder unit 12, and the movement of the lens holder unit 12 causes the reset spring 126 to compress or stretch. The second fastening hole 152 is corresponding to the second guiding pin 112. To be specific, the second guiding pin 112 penetrates the second guiding hole 124 and then penetrates into the second fastening hole 152.

The shell 16 is provided with a shell opening 016 corresponding to the base opening O11 and the lens holder opening O12, so that light can be focused for imaging through a lens disposed in the lens holder unit 12. The shell 16 is connected to the base 11 to envelop and accommodate the lens holder unit 12, the driving unit 13, the circuit unit 14, and the upper cover 15, to form the lens actuation device 10.

The use of the lens actuation device 10 of the present invention is further described to make the content of the present invention clearer.

The lens actuation device 10 uses, through the rotating output shaft 132 and the lifting nut 133, the driving unit 13 to enable the lens holder unit 12 to move vertically. For example, the driving control element 142 provides an electric current to the driving unit 13 (stepping motor), to control forward rotation and then lift the lens holder unit 12, or to control reverse rotation and then cause the lens holder unit 12 to descend through the reset spring 126. When the output shaft 132 rotates, the lifting nut 133 is restricted from rotating by the limiting element 128 of the lens holder unit 12. Therefore, the lifting nut 133 cannot rotate in situ and moves up and down along the output shaft 132. Because the lifting nut 133 is located between the first extension part 121 and the third part 1343 of the support 134, the movement of the lifting nut 133 can cause the lens holder unit 12 to be displaced.

When the lens holder unit 12 is equipped with an optical lens and moves up and down, the first guiding pin 111 moves along the guiding tube 125 that is closed, thereby preventing tilting when the lens holder unit 12 moves. In addition, the second guiding pin 112 is connected to the second guiding hole 124 that is semi-enclosed, to restrict the rotation of the lens holder unit 12. A movement direction of the lens holder unit 12 can be limited through the first guiding pin 111, the second guiding pin 112, and a corresponding structure by using the above structure, to prevent inclination or rotation. In addition, when the sensing element 143 and positioning element 129 are provided, a position of the lens holder unit 12 can be accurately obtained, and the position can be precisely controlled. When the lens holder unit 12 is equipped with the optical lens, precise auto focus can be implemented.

To sum up, for the lens actuation device of the present invention, the reset spring, the guiding tube connected to the first guiding pin, and the driving unit are designed in a centralized manner on a same regional structure. In such design, the size of the lens actuation device is reduced, and the overall movement is more compact and stable. In addition, in the lens actuation device of the present invention, through mutual cooperation of the guiding pin, the guiding hole, and the guiding tube, and through a connection relationship between the output shaft of the driving unit and the lifting nut, tilting and rotation of the lens holder unit during movement can be prevented, and then accurate focusing position control can be further obtained.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A lens actuation device, comprising:
a base, provided with a base opening, a first guiding pin, and a second guiding pin, wherein the first guiding pin and the second guiding pin are respectively disposed on a surface on two sides of the base opening;
a lens holder unit, provided with a lens holder opening, a first extension part, a second extension part, a first guiding hole, a second guiding hole, a guiding tube, and a limiting element, wherein the lens holder opening corresponds to the base opening, the first extension part and the second extension part extend outward from the lens holder opening, the first guiding hole is formed in the first extension part, the second guiding hole is formed in the second extension part, the guiding tube corresponds to the first guiding hole and is disposed on one side of the first extension part, the first guiding pin penetrates into the guiding tube, and the limiting element is disposed on the other side of the first extension part; and
a driving unit, provided with a motor body, an output shaft, and a lifting nut, wherein a part of the output shaft is connected to the motor body, the other part of the output shaft is screwed with the lifting nut, a part of the first extension part of the lens holder unit is located between the motor body and the lifting nut, and the lifting nut is limited by the limiting element to rotate relative to the limiting element.

2. The lens actuation device according to claim 1, further comprising:
a circuit unit, provided with a circuit board, a driving control element, and a sensing element, wherein the circuit unit is disposed on one side of the base and the lens holder unit, and a surface of the circuit board faces the base and the lens holder unit; and
the sensing element is disposed on the surface of the circuit board and is disposed to be opposite to a positioning element of the lens holder unit.

3. The lens actuation device according to claim 2, wherein the sensing element is either a light sensing element or a magnetic field sensing element.

4. The lens actuation device according to claim 2, further comprising a shell, wherein the shell is provided with a shell opening corresponding to the base opening and the lens holder opening, and the shell is connected to the base to envelop the lens holder unit, the driving unit, and the circuit unit.

5. The lens actuation device according to claim 1, wherein the limiting element of the lens holder unit is further provided with a first limiting column and a second limiting column, the lifting nut is provided with a protrusion or a limiting shape, and the protrusion or the limiting shape is located between the first limiting column and the second limiting column and is restricted in movement.

6. The lens actuation device according to claim 1, wherein the driving unit is further provided with a support, and the support is provided with:
a first part, abutting against a side that is of the output shaft of the motor body and that extends outward;
a second part, connected to the first part; and
a third part, connected to the second part and disposed to be opposite to the first part, wherein one terminal end of the output shaft is connected to the third part, and the lifting nut is located between the first part and the third part.

7. The lens actuation device according to claim 6, wherein the base is further provided with:
a setting groove, located on one side of the first guiding pin;
a first support column, disposed on one side of the setting groove; and
a second support column, disposed on the other side of the setting groove,
wherein the support is disposed in the setting groove and is connected to the first support column and the second support column separately.

8. The lens actuation device according to claim 1, wherein the lens holder unit is further provided with:
a reset spring, sleeved on an outer side of the guiding tube; and
a longitudinal groove, located on one side of the first extension part, wherein the output shaft of the driving unit penetrates into the longitudinal groove.

9. The lens actuation device according to claim 8, further comprising an upper cover, wherein the upper cover is superimposed on the lens holder unit and is provided with a first fastening hole and a second fastening hole, the first fastening hole is disposed corresponding to the first guiding pin, the second fastening hole is disposed corresponding to the second guiding pin, and the guiding tube and the reset spring are located between the upper cover and the first extension part of the lens holder unit.
